(19) United States
(12) Patent Application Publication
(10) Pub. No.: US 2025/0121495 A1
(43) Pub. Date: Apr. 17, 2025

(54) ROBOT ARM CONTROLLER WITH HAPTIC FEEDBACK TO AN OPERATOR DURING CONTROL

(71) Applicant: fsk industries GmbH & Co. KG, Gummersbach (DE)

(72) Inventor: Nils Kühle, Meckenheim (DE)

(21) Appl. No.: 18/913,482

(22) Filed: Oct. 11, 2024

(30) Foreign Application Priority Data
Oct. 11, 2023 (DE) 10 2023 127 790.1

(51) Int. Cl. B25J 9/16

(52) U.S. Cl. CPC B25J 9/1633; B25J 9/1664; B25J 9/1669

(57) ABSTRACT

A robot for holding and processing a workpiece includes: a controller for controlling: a holding device, and a manipulator arm; and a multi-link manipulator arm, which has a handle piece, wherein the manipulator arm can determine forces exerted on the handle piece of the manipulator arm and transmit corresponding information to the controller. A holding device may be connected to the controller for information purposes for holding the workpiece. The holding device can move the workpiece linearly or rotationally, and the controller can control the holding device or the manipulator arm to move a position of the workpiece relative to the manipulator arm linearly or rotationally in accordance with the forces determined via the manipulator arm. The controller may also deflect the handle piece of the manipulator arm linearly or rotationally from a starting position simultaneously with the actuation of the holding device based on the determined forces.

The present invention relates to a robot arm control with haptic feedback to an operator during control.

Manipulator arms are known, particularly in industrial robots, with associated robot control. Industrial robots can be equipped with tools on their manipulator arms, for example, and hold these tools. Typical tools include tools for processing metal, such as welding, milling or grinding heads.

Manipulator arms usually have several link elements that can position and control a held tool in terms of orientation and position via electrically driven joints.

In the automotive industry, for example, such robots are used for automated welding work, wherein the robots carry out steps of a stored program.

It is also known to move industrial robots on linear axes by means of a stored program control or as a so-called external axis integrated in the robot control along a linear axis.

It is also known to operate such industrial robots in collaboration with an operator as so-called cobots (collaborating robot). These cobots differ from conventional industrial robots in that they are suitable for direct interaction between humans and machines. These robots can perform automated process steps according to a predefined program as well as directly perform process steps while the robot is guided by an operator. In the second case, the robot is used as a support for the operator. The robot can then position and orient a tool to a workpiece, wherein the operator guides and controls the robot.

The present invention is based on the object of making the control of the robot intuitive and simple for the operator.

This problem is solved by the features of the independent claims. Further advantageous embodiments of the invention are specified in the dependent claims. The features listed individually in the dependently formulated claims can be combined with one another in a technologically useful manner and can define further embodiments of the invention.

A robot for holding and processing a workpiece is presented, which comprises a controller for controlling a holding device and for controlling a manipulator arm as well as a corresponding multi-link manipulator arm. The manipulator arm has a handle piece, wherein the manipulator arm is set up to determine forces exerted by the operator on the handle piece of the manipulator arm and to transmit corresponding information to the controller. Furthermore, the robot comprises a holding device for holding the workpiece or a tool. In one embodiment, the holding device can be arranged at the distal end of the manipulator arm. In another embodiment, the holding device can be arranged at the proximal end of the manipulator arm. The holding device is informatively connected to the controller and is set up to move the workpiece linearly or rotationally, for example. The controller is set up to control the holding device and/or the manipulator arm to move the position of the workpiece relative to the manipulator arm linearly or rotationally according to the forces determined via the manipulator arm. The controller is set up to deflect the handle piece of the manipulator arm linearly or rotationally from a starting position simultaneously with the control of the holding device based on the forces determined via the manipulator arm. The expression “simultaneously” describes the fact that the application of a force and the resulting deflection of the manipulator arm are simultaneous in the perception of the operator, i.e. the deflection is not noticeably different in time from the application of the force. This is because the time required to transmit and process signals is typically negligible or subjectively imperceptible to an operator. The deflection of the manipulator arm from a previous reference or starting position ends as soon as it is determined that no more force is being exerted on the handle piece. Accordingly, the manipulator arm is then returned to a previous output or reference position.

The manipulator arm has a distal end and a proximal end, wherein the proximal end is connected to the foundation or workbench or other suitable bracket. Furthermore, the manipulator arm can comprise several link elements that are connected to one another in a movable manner via joints and axes. For this purpose, the manipulator arm can have motors, transmissions and angle encoders that move the manipulator arm. The manipulator arm can also have lines for power supply, control and signal transmission.

In particular, the manipulator arm has at least two link elements. The link elements are sequentially connected to one another via joints. The joints can be driven by electric motors, wherein a joint can be moved in several degrees of freedom. In particular, the joint can have a rotational degree of freedom. Preferably, a joint has two rotational degrees of freedom. A robot with a multi-link manipulator arm has the technical advantage that more complex movements are possible and the manipulator arm can also position and orient its distal end at points on the workpiece that are otherwise difficult or impossible to reach.

The workpiece can be made of any material. For example, it can be metallic or mineral, preferably the workpiece can be a plastic, and particularly preferably the workpiece can be a mixture of different materials.

Processing means that a tool is guided to the workpiece and the workpiece is processed with the tool. Processing can also mean that a workpiece is guided to the tool and the workpiece is processed with the tool. In particular, something can be mounted on the workpiece and/or removed. Known manufacturing processes can be used for this. Processing can also mean that the workpiece is positioned or measured.

The manipulator arm has a handle piece which is typically arranged at its distal end so that it is close to the tool which can be arranged at the end of the manipulator arm. An operator can control the manipulator arm using the handle piece. To do this, the operator can grip the handle piece and exert a force on it, for example in one direction.

The handle piece may also be any area of the manipulator arm that is suitable and intended to be gripped by an operator to exert a force on the manipulator arm that is not necessarily ergonomically shaped. Preferably, the handle piece or handle area is an area at the distal end of the manipulator arm. In an alternative embodiment, the handle piece is an area of the tool.

The manipulator arm is set up to determine the forces exerted on the handle piece of the manipulator arm and transmit the corresponding information to the controller. A force can also be a torque around an axis of rotation. The manipulator arm initially holds its pose and/or position. A pose of the manipulator arm means that the several elements of the manipulator arm do not move in relation to one another and therefore the current shape of the manipulator arm does not change, apart from a deflection of the handle from an starting position. The force exerted by the operator on the handle piece is then transferred to the manipulator arm. To measure the force, a suitable sensor is attached to/in the manipulator arm, in one embodiment a force load cell, also known as a force transducer or force sensor, which determines the forces exerted on the handle piece of the manipulator arm and transmits corresponding information to the controller. In another embodiment, a suitable sensor can measure the forces at the joints of the manipulator arm.

A force on the handle piece can be vectorially decomposed into different orientations. It is advantageous to assign the forces to three mutually orthogonal directions. In particular, the orientation can be assigned to a force along a linear axis of movement of the robot.

Any undesired direction of movement of the manipulator arm can be immediately registered as a force on the handle piece and transmitted to the controller accordingly. As described below, an operator can make an appropriate input to the controller to specify that only predefined directions of a force should be taken into account for controlling the holding device or the manipulator arm.

In this manner, the forces and force changes of the operator on the handle piece can be determined in a dedicated manner so that, for example, a force is vectorially decomposed in two directions. In this manner, for example, a force can be ignored in a direction that would lead to a movement of the manipulator arm or the workpiece that is undesirable. This can increase safety in the interaction between humans and machines.

A determined force can be used both to control the holding device in order to move it in a desired direction or to rotate it, and to control the manipulator arm in order to move it from a starting position in accordance with the determined force and to provide the operator with haptic feedback. The operator can thus not only see that the force exerted on the handle piece causes the workpiece to move accordingly, but also receives haptic “feedback”.

The controller is connected to the holding device for information purposes so that the controller can transmit control instructions to the holding device. The holding device is set up to hold the workpiece, wherein the holding device is set up for the linear or rotational method of the workpiece. For example, the operator can push the handle piece away from them or pull it towards them in order to rotate the workpiece, wherein the speed of rotation increases with increasing pushing or pulling force and ends as soon as the operator no longer exerts any pushing or pulling force on the handle piece, and wherein the controller simultaneously controls the manipulator arm as a function of the magnitude of the pushing or pulling force so that the handle piece is deflected from its original starting position as a function of the force. Accordingly, the controller controls the manipulator arm so that the handle piece returns to its starting position when the force decreases.

The holding device can have at least one axis of rotation around which the workpiece can be rotated. However, the holding device can also have at least one linear axis along which the workpiece can be moved linearly. For this purpose, the holding device can have electric linear and/or rotary drives.

Furthermore, the operator can exert a force on the handle piece to move the manipulator arm in a rigid pose along a linear axis in the direction corresponding to the direction of force. A rigid pose is one that only allows the handle piece to be deflected as long as a force is exerted on the handle piece. For example, the operator can use it to push the handle piece to the side and thereby move the manipulator arm in an otherwise rigid pose along a linear axis in the corresponding direction, wherein the handle piece is deflected during the method.

The starting position is a relative position of the handle piece in relation to a rigid pose of the manipulator arm. The output or reference position can also be referred to as the rest position. In other words, the starting position can also be described in a simplified manner using vectors. Starting from a coordinate origin, the proximal end of the manipulator arm can be described as a position vector. This position vector can be changed, for example, by moving the manipulator arm on a linear axis. A handle piece vector refers to a vector from the proximal end of the manipulator arm to the handle piece. If the manipulator arm is in a fixed pose, the handle vector is the deflection.

In the rigid pose of the manipulator arm, the handle piece of the manipulator arm can be deflected along an allowed deflection distance and/or rotated along an allowed rotation angle. The greater the force exerted on the handle piece, the faster the linear or rotational movement of the rigid pose of the manipulator arm or the holding device can be executed. As a greater force on the handle piece typically causes a correspondingly greater deflection of the handle piece, the handle piece is also deflected further along the permitted deflection distance from the starting position.

The robot operator thus receives haptic feedback on the force exerted by the manipulator arm simultaneously with the control of the holding device on the handle piece.

In this manner, a tool can be particularly easily guided and positioned relative to a workpiece. Furthermore, the interaction between humans and robots is intuitive thanks to the haptic feedback. This makes it easier to control the robot and at the same time increases safety during operation.

In one embodiment, the robot is designed as a cobot (collaborative robot). Cobots can perform automated process steps according to a predefined program as well as directly perform process steps while the cobot is guided by an operator. In the second case, the cobot is used to assist the operator. A cobot has the advantage of enabling particularly safe collaboration with an operator.

In a further embodiment of the robot, the multi-link manipulator arm is set up at its distal end for the receptacle of a tool for processing the workpiece.

The tool can be adjacent to the handle piece of the manipulator arm in the distal direction of the manipulator arm, so that in the distal direction the handle piece is the last element of the manipulator arm before the tool. A tool can be a welding tool and/or a cutting tool, preferably a positioning tool or particularly preferably a measuring tool.

In another embodiment of the robot, the deflection of the manipulator arm is non-linear based on the forces determined via the handle piece of the manipulator arm.

In one embodiment, the deflection of the handle piece of the manipulator arm can increase non-linearly to a determined exerted force, so that a force twice as great does not produce twice the deflection of the manipulator arm, but only a smaller deflection. In particular, the path length of the deflection of the manipulator arm can be logarithmic to the determined force. In one embodiment, for example, the deflection distance for a quadruple force can be only twice as large.

Accordingly, the control can be set up to move a workpiece along a straight axis or to rotate it about an axis, wherein the traversing or rotation speed is dependent on the magnitude of the force determined.

In one embodiment, the traversing or rotational speed of the workpiece is linear to the magnitude of the determined force, so that a force twice as large causes a corresponding double traversing or rotational speed.

In another embodiment, the traversing or rotational speed of the workpiece can increase non-linearly to the magnitude of the determined force, so that, for example, a twofold force causes a fourfold traversing or rotational speed.

The non-linear increase in the traversing or rotational speed of the workpiece with an increase in the determined force on the handle piece enables comparatively fast traversing or rotation of the workpiece when a large force is exerted on the handle piece and determined and, conversely, slower traversing or rotation when a smaller force is determined. This enables an operator to position the workpiece precisely at low traversing or rotation speeds and to move or rotate the workpiece disproportionately quickly when the operator exerts greater forces on the handle piece.

In one embodiment, the deflection of the manipulator arm based on the forces determined via the handle piece of the manipulator arm is linear to the force determined.

The controller can then be set up to move a position of the workpiece linearly or rotationally at a linearly increasing speed corresponding to the determined force in accordance with the linear increase in forces determined via the manipulator arm. The advantage is that controlling the robot becomes more intuitive with clear haptic feedback to the operator. Thus, stronger movements on the handle piece result in proportional movements of the manipulator arm and/or the holding device, without disproportionately high traversing or rotational speeds being achieved with large forces. This embodiment is particularly advantageous for inexperienced operators, as the robot behaves proportionally to the force exerted by the operator.

In one embodiment, the manipulator arm is detachably fixed at its proximal end relative to the holding device. For example, the manipulator arm can be moved along the linear axis on an electrically driven linear axis. The manipulator arm can thus be moved along at least one axis.

The manipulator arm can also be moved along several mutually orthogonal axes. Preferably, the proximal end of the manipulator arm can be moved along two orthogonal axes on an electrically driven horizontal linear table. It is particularly preferred that the proximal end of the manipulator arm can also be moved along the vertical third axis using a lifting device. In this manner, the robot has a greater processing range without adding further link elements to the manipulator arm. Furthermore, in human-machine interaction, the robot can better follow the operator's range of movement.

In another preferred embodiment, previous embodiments are combined with this feature so that an operator applies a force to the handle piece and the controller moves the proximal end of the robotic arm according to the applied force. The advantage of this is that the operator can use the robot intuitively with haptic feedback during control and a greater processing range can be used.

In one embodiment, the robot has a switch. The operator can select, by actuating a switch or a combination of switch actuations, along which axis a workpiece is to be moved or about which axis a workpiece is to be rotated or the proximal end of the manipulator arm is to be moved when the operator exerts a force in a predefined direction on the handle piece.

Preferably, the robot has one or more push buttons or buttons on the handle piece that an operator can operate when gripping the handle piece.

In one embodiment, the operator can press a button to select whether the workpiece is to be moved along a linear axis in the direction of the pressure or whether the workpiece is to be rotated about a rotation axis when pressure is applied to the handle piece. By pressing various button combinations, the operator can select along which axis a workpiece is moved linearly or rotated or the proximal end of the robot is moved or rotated.

Another aspect of the invention is a method for controlling the robot. The method comprises the steps:
a) determining the forces exerted on the handle piece of the manipulator arm,
b) transmitting the relevant information to the controller,
c) holding the workpiece in the holding device,
d) controlling the holding device or the manipulator arm to move a position of the workpiece relative to the manipulator arm linearly or rotationally according to the forces determined via the manipulator arm,
e) rotational or linear deflection of the handle piece of the manipulator arm simultaneously with the control of the holding device based on the forces determined from a starting position.

Typically, an operator actuates a switch on the robot, in one embodiment a push button, before applying a force to the handle piece to indicate to the controller that a subsequent force applied to the handle piece is to be determined and used for a method of holding the holding device or manipulator arm.

The deflection of the manipulator arm from a previous starting position ends as soon as it is determined that no more force is being exerted on the handle piece. Accordingly, the manipulator arm is then returned to a previous starting position when the holding device has been activated for the method. If the position of the manipulator arm has been moved, the proximal end of the manipulator arm remains in its new position, but the deflection of the handle piece ends as soon as no more force is exerted on the handle piece. The operator can use various buttons or actuations to signal to the controller whether the manipulator arm or the holding device should be moved or along which axes the workpiece or the manipulator arm should be moved or rotated.

An operator receives haptic feedback on the force exerted on the handle piece via the deflection of the handle piece, i.e. feedback, so that controlling the robot is intuitive and simple. This makes it easy to position and orient a workpiece.

The method for controlling a robot with corresponding program commands can be implemented as software. The software can be executed as an executable program by the robot's controller and control the robot accordingly.

In the following, the invention and the technical environment will be explained in more detail with reference to the figures. It should be noted that the invention should not be limited by the embodiments shown. In particular, it must be noted that the figures and in particular the depicted size ratios are only schematic. Identical reference signs denote identical objects, so that explanations from other figures can be used in a supplementary manner, if necessary. In the drawings:

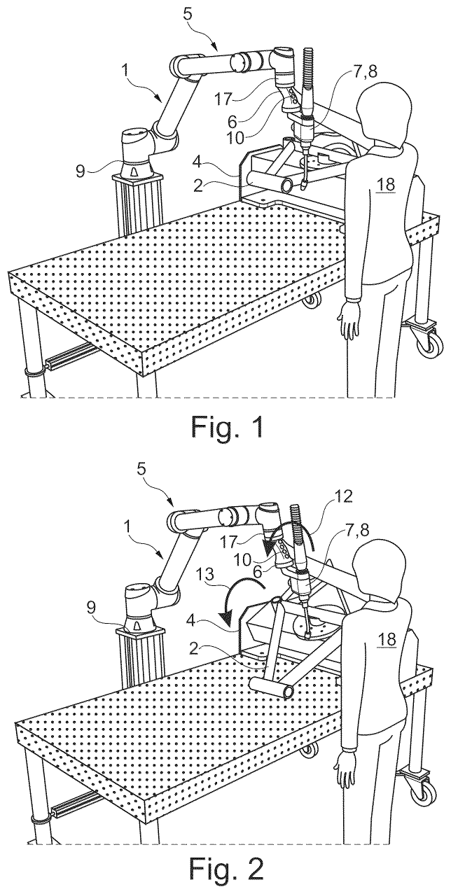

FIG. 1: shows a perspective view of a robot according to the invention for holding and processing a workpiece,

FIG. 2: shows a perspective view of a robot according to the invention from FIG. 1,

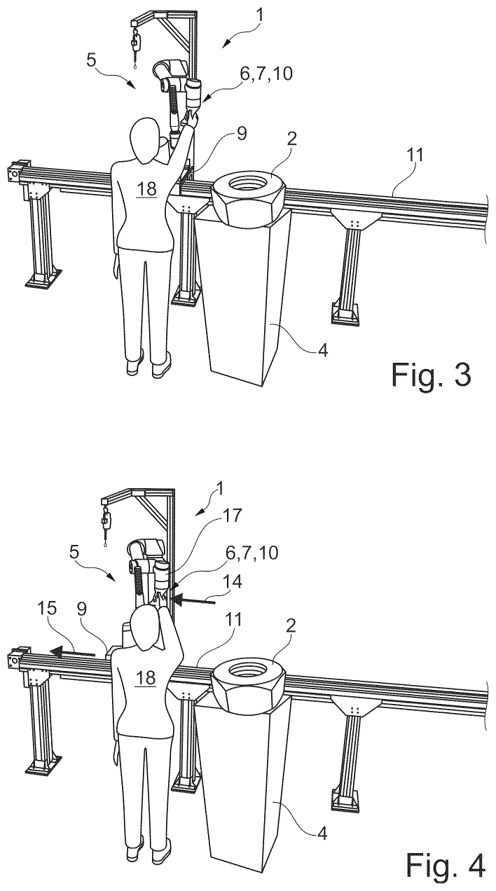

FIG. 3: shows a perspective view of another robot according to the invention for holding and processing a workpiece before a linear displacement,

FIG. 4: shows a perspective view of a robot according to the invention from FIG. 3,

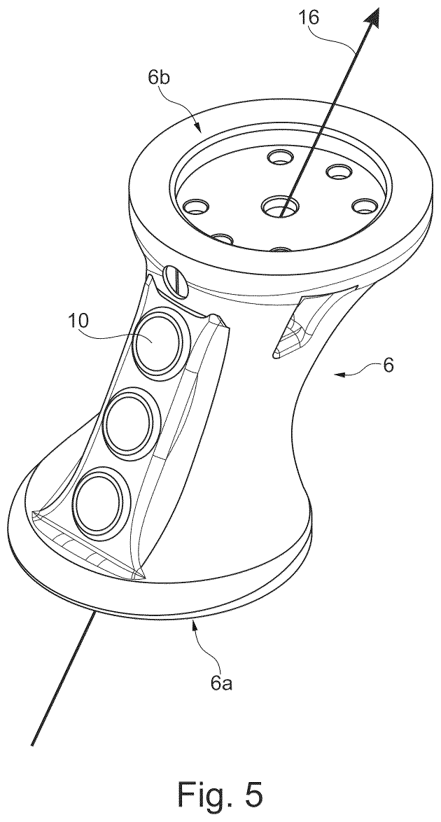

FIG. 5: shows a perspective view of a handle piece of a manipulator arm from FIG. 1 to FIG. 4.

FIG. 1 shows a perspective view of a robot 1 according to the invention for holding and processing a workpiece 2, which is operated by an operator 18.

The robot 1 comprises a multi-link manipulator arm 5, a holding device 4 and a controller. The robot 1 is a cobot and is suitable for human-machine interaction.

The controls are not shown in this and the other figures. The controller receives information from the manipulator arm, in particular measured values for the position and forces acting on the manipulator arm, and controls it and the holding device 4.

The holding device 4 is set up and intended to hold a workpiece 2 to be processed by the robot 1. The controller controls the holding device 4 accordingly, so that the holding device 4 moves the workpiece along a linear axis or rotates about an axis, i.e. changes the pose of the workpiece relative to the manipulator arm 5, as required for processing with a tool.

The manipulator arm 5 is fixed at its proximal end 9 relative to the holding device 4. At its distal end 7, the manipulator arm is set up for the receptacle of a tool 8. The robot 1 can use the tool 8 to process the workpiece 2, which is held in the holding device 4.

The manipulator arm 5 has a handle piece 6. The manipulator arm 5 comprises motors and drives to move or rotate the links of the manipulator arm 5. Furthermore, the manipulator arm 5 comprises sensors and is set up to determine the forces exerted by an operator 18 on the handle piece 6 of the manipulator arm 5 and to transmit corresponding information to the controller. The forces can be along a linear axis, i.e. when an operator exerts a force in a straight direction, for example when he exerts a force to one side on the handle piece 6 and thus the manipulator arm 5, for example when he pushes the handle piece 6 away from him towards the rear or pulls it towards him. The direction of the force can also be vertical, i.e. upwards or downwards.

Alternatively, a force may be rotational, i.e. when an operator 18 exerts a moment on the handle piece 6, i.e. attempts to rotate the handle piece 6 about its central axis.

The robot 1 allows the handle piece 6 to be deflected in the direction of the linear or rotational force exerted. In one embodiment, the deflection can take place wherein the manipulator arm 5 is not completely rigid, but flexible, wherein the manipulator arm 5 returns to its corresponding starting position as soon as the deflecting force is no longer exerted.

In an alternative embodiment, the controller of the robot controls the actuators and motors of the manipulator arm 5 in such a manner that the handle piece 6 is deflected from its starting position in accordance with the force determined. Accordingly, the handle piece is moved back to its starting position as soon as the operator 18 no longer exerts the force on the handle piece 6. In this embodiment, the controller of the robot 1 controls the path or the angle of rotation of the deflection linearly or non-linearly to the determined force.

With a deflection proportional to the determined force, the length of the displacement or the rotation angle of the deflection is directly proportional to the force determined on the handle piece 6 (linear assignment of force to displacement/rotation angle). If the force is twice as great, the distance traveled or the angle of rotation of the deflection is correspondingly twice as great. In a further embodiment, the assignment of displacement or rotation angle to a determined force can also be non-proportional, so that a larger force causes a larger deflection path or rotation angle, but the assignment of force to displacement or rotation angle is not linear. With such a non-proportional control, the control can control the displacement of the deflection or the angle of rotation in such a manner that four times the determined force must be applied to the handle piece 6 for twice the displacement of the deflection or twice the angle of rotation.

The controller is connected to the holding device 4 for information purposes, i.e. to exchange determined information and control instructions. The holding device 4 is set up to move the workpiece 2 linearly or rotationally.

The controller is set up to control the holding device 4 and/or the manipulator arm 5. For this purpose, the controller can send control instructions to the holding device 4 so that it moves a position of the workpiece 2 relative to the manipulator arm 5 in a linear or rotational manner. The controller is set up to deflect the handle piece 6 of the manipulator arm 5 linearly or rotationally from a starting position simultaneously with the control of the holding device 4, also based on the forces determined via the manipulator arm 5.

The manipulator arm 5 is provided at its distal end 7 for holding or receiving a tool 8 with which the workpiece 2 can be processed. The deflection of the manipulator arm 5, i.e. the displacement of the deflection, in one embodiment is not proportional to the forces exerted and determined on the manipulator arm 5.

FIG. 2 shows a perspective view of a robot 1 according to the invention from FIG. 1. The robot 1 is controlled by the following steps so that the holding device 4 rotates the workpiece 2. The operator 18 grasps the handle piece 6 and actuates a switch or pushbutton 10 of the handle piece 6. Actuating the switch or pushbutton 10 signals to the controller that a force subsequently exerted on the handle piece 6 is to be determined and processed in accordance with the actuation of a pushbutton. The handle piece 6 can have one or more pushbuttons 10 for this purpose. The controller is set up to process the subsequently determined force for various pushbuttons 10 or during/after actuation of one or more pushbuttons 10, i.e. to control both the deflection of the manipulator arm 5 and the changing of the pose of the manipulator arm 5. In one embodiment, a predefined sequence of pushbutton actuations can be used to select that a subsequent force on the handle piece 6 should apply to a specific movement. An operator can thus select that the controller should only process a subsequent input for a selected movement, for example a specific linear movement or a specific rotation around a specific axis. In this manner, forces that the operator 18 exerts on the handle piece 6 in a direction other than the selected direction are not taken into account.

FIG. 2 shows an operator 18 exerting a force on the handle piece 6, in this case a rotational force, see arrow 12. The sensors of the manipulator arm 5 determine the force and the manipulator arm 5 signals the corresponding information to the controller. The controller then controls both the holding device 4 and the manipulator arm 5 accordingly, so that the holding device 4 moves the workpiece 2, see arrow 13, and simultaneously deflects the handle piece 6.

As shown in FIG. 2, the handle piece 6 is deflected from the initial position with a force along a first rotary movement 12. The holding device 4 rotates in a second rotary movement 13 until the handle piece 6 is back in the starting position. As long as the operator 18 exerts a corresponding force on the handle piece via the rotary movement, the holding device 4 moves the workpiece 2.

FIGS. 3 and 4 show a perspective view of a manipulator arm 5 of a robot 1 according to the invention, wherein the manipulator arm 5 can be moved along a rectilinear guide 11. Analogous to the method described below for the manipulator arm of a robot 1 along a rectilinear guide, a manipulator arm 5 can also rotate relative to the workbench or foundation to which it is fixed by its proximal end 9.

FIG. 3 shows the manipulator arm 5 and the handle piece 6 in the initial position, i.e. before the manipulator arm 5 is moved. The operator 18 actuates one or more pushbuttons 10 of the handle piece 6 before or during the subsequent traversing operation, so that the controller is signaled that the subsequent operation is directed towards a traversing operation of the manipulator arm 5. Accordingly, the controller will assign the forces determined below, see FIG. 4, on the handle piece 6 to a movement of the manipulator arm 5.

As shown in FIG. 4, an operator 18 exerts a force directed to the side, see arrow 14, on the handle piece 6 of the manipulator arm 5 in port of actuating a pushbutton 10. As described above, the sensors 17 determine the direction and magnitude of the force exerted and send the corresponding information to the controller. The controller controls the robot 1 to move the manipulator arm 5 in the direction of the force 14, see arrow 15. The speed of the method used by the manipulator arm 5 depends on the force exerted by the operator 18 on the handle piece 6. At the same time as the manipulator arm 5 is moved, the controller 3 controls the manipulator arm 5 to deflect the handle piece 6 according to the force exerted. In this case, deflection of the handle piece 6 can be a movement of the handle piece 6 relative to the manipulator arm 5.

FIG. 5 shows a perspective view of a handle piece 6 shown in FIG. 1 to FIG. 4. The handle piece 6 is mounted on the manipulator arm, wherein the handle piece 6 is placed on the manipulator arm in an offset position relative to the manipulator arm. The mounting surfaces 6a, 6b of the handle piece are parallel, but the surface normals are not parallel to the axis 16 of the handle piece. When mounted, the handle piece 6 is thus ergonomically arranged in the manipulator arm, so that the pushbuttons 10 are also ergonomically arranged. In one embodiment, the handle piece 6 can have one or more pushbuttons on one side of the handle piece 6, which is visible here, and at least one further switch or pushbutton on the opposite side of the handle piece 6, which is not visible here.

Typically, the handle piece 6 is arranged in the manipulator arm between the last link of the manipulator arm and a tool 8 held by the manipulator arm.

### LIST OF REFERENCE SIGNS

1 robot, cobot
2 workpiece
3 controller
4 holding device
5 manipulator arm
6 handle piece
6a,6b mounting surfaces
7 distal end
8 tool
9 proximal end
10 switch, pushbutton
11 linear guide
12 first rotary movement
13 second rotary movement
14 force on the handle piece
15 direction of movement of the manipulator arm
16 axis of the handle piece
17 sensors, force load cell
18 operator

1. A robot for holding and processing a workpiece, comprising a controller for controlling a holding device and for controlling a manipulator arm; and
a multi-link manipulator arm which has a handle piece, wherein the manipulator arm is set up to determine forces exerted on the handle piece of the manipulator arm and to transmit corresponding information to the controller,
a holding device informatively connected to the controller for holding the workpiece, wherein the holding device is set up to move the workpiece linearly or rotationally,
and wherein
the controller is set up to control the holding device or the manipulator arm to move a position of the workpiece relative to the manipulator arm linearly or rotationally in accordance with the forces determined via the manipulator arm; and
the controller is set up to deflect the handle piece of the manipulator arm linearly or rotationally from a starting position simultaneously with the control of the holding device based on the forces determined via the manipulator arm.

2. The robot according to claim 1, wherein the robot is a cobot.

3. The robot according to claim 1, wherein the multi-link manipulator arm is adapted at its distal end for receptacle of a tool for processing the workpiece.

4. The robot according to claim 1, to any of the preceding claims, wherein the deflection of the manipulator arm is non-linear based on the forces detected via the manipulator arm.

5. The robot according to claim 1, wherein the deflection of the manipulator arm is linear based on the forces determined via the manipulator arm.

6. The robot according to claim 1, wherein the controller is arranged to actuate the manipulator arm or to move the proximal end of the manipulator arm linearly or rotationally in accordance with the forces determined via the manipulator arm.

7. The robot according to claim 1, wherein the manipulator arm is detachably fixed at its proximal end relative to the holding device.

8. The robot according to claim 1, wherein the controller is arranged to control the holding device to move the position of the workpiece linearly or rotationally in accordance with the forces determined via the manipulator arm.

9. The robot according to claim 1, wherein the manipulator arm has a switch.

4. A method for controlling a robot, comprising:
providing a controller for controlling a holding device and for controlling a manipulator arm, a multi-link manipulator arm which has a handle piece, wherein the manipulator arm is set up to determine forces exerted on the handle piece of the manipulator arm and to transmit corresponding information to the controller, and a holding device informatively connected to the controller for holding the workpiece, wherein the holding device is set up to move the workpiece linearly or rotationally:
wherein
the controller is set up to control the holding device or the manipulator arm to move a position of the workpiece relative to the manipulator arm linearly or rotationally in accordance with the forces determined via the manipulator arm: and
the controller is set up to deflect the handle piece of the manipulator arm linearly or rotationally from a starting position simultaneously with the control of the holding device based on the forces determined via the manipulator arm;
determining the forces exerted on the handle piece of the manipulator arm,
transmitting the corresponding information to the controller,
holding the workpiece in the holding device,
controlling the holding device or the manipulator arm to move a position of the workpiece relative to the manipulator arm linearly or rotationally in accordance with the forces determined via the manipulator arm,
rotational or linear deflection of the handle piece of the manipulator arm simultaneously with the control of the holding device based on the forces determined via the manipulator arm from a starting position.

11. The method according to claim 10, wherein the deflection of the manipulator arm is non-linear based on the forces determined via the manipulator arm.

12. The method according to claim 10, wherein the deflection of the manipulator arm is linear based on the forces determined via the manipulator arm.

13. A storage medium with software controlling a robot for performing a method according to claim 10.
